(19) United States
(12) Patent Application Publication
(10) Pub. No.: US 2020/0295701 A1
(43) Pub. Date: Sep. 17, 2020

(54) LOAD-BEARING STRUCTURE FOR SINGLE-AXIS FOR TRACKING PHOTOVOLTAIC PANELS

(71) Applicant: S.B. SOLAR SRL, Verolanuova (BS) (IT)

(72) Inventor: Luigi SPEDINI, Cremona (CR) (IT)

(21) Appl. No.: 16/082,205

(22) PCT Filed: Mar. 2, 2017
(86) PCT No.: PCT/IT2017/000043

§ 371 Date: Sep. 4, 2018

(30) Foreign Application Priority Data
Mar. 3, 2016 (IT) 202016000022163

(51) Int. Cl. H02S 20/32; H02S 30/10

(52) U.S. Cl. CPC H02S 20/32; H02S 30/10

(57) ABSTRACT

Disclosed is a load-bearing structure for single-axis for tracking photovoltaic panels including: first and second support beams for photovoltaic panels, having a longitudinal axis; crosspieces fixing the photovoltaic panels to the first and second beams; support poles for the first and second beam, secured to the ground and having a hinge allowing rotation of the beams about their axis; a linear actuator with first and second ends, the first being hinged to one of the support poles of the first beam; first and second cranks associated respectively with the first and second beams, and imparting a rotation movement thereto; and a connecting rod between the first and second cranks. The second end of the linear actuator is hinged to the connecting rod, allowing simultaneous and coordinated movement of the first and second cranks and the consequent simultaneous and coordinated rotation of the first and second beam of the structure.

### TECHNICAL FIELD

The invention relates to the field of photovoltaic system construction.

More in detail, the invention relates to a load-bearing structure for single-axis for tracking photovoltaic panels.

### BACKGROUND ART

To build systems with noteworthy production capacities, the photovoltaic panels are installed on free surfaces that can be very large, such as parking areas or parks, large areas of fallow land, etc., supported by specific load-bearing structures.

The photovoltaic panels are arranged so as to optimize the absorption of solar energy. To increase the energy output, the panels are advantageously mounted on moving load-bearing structures, so as to allow the sun's rays to strike the panels with an angular incidence that ensures the best possible output at all times. For this purpose the load-bearing structures of the panels are controlled by mean of “tracking” devices, which control the east-west orientation of the same panels, as a function of the position of the sun.

During daylight hours, solar trackers of single-axis type track the solar radiation only rotating about a north-south azimuth axis, and therefore offer higher performances in the generation of electrical current with respect to a conventional stationary photovoltaic system.

A prior art technique provides for fixing the solar panels, coupled to one another to define photovoltaic arrays, to linear load-bearing structures, providing each load-bearing structure with an actuator fitted to a crank drive, adapted to orient the panels associated therewith.

By arranging numerous linear load-bearing structures parallel to one another, systems with large production capacities are obtained.

Each load-bearing structure essentially comprises:
a support beam for the photovoltaic panels having a longitudinal axis adapted to be arranged in north-south direction and, for example, a quadrangular or round cross section;
a plurality of support poles for said beam, arranged equidistant to one another, secured to the ground and provided, at the free end thereof, with a hinge connection, adapted to allow rotation of said beam;
a plurality of crosspieces, for example with an Ω cross section, for fixing said photovoltaic panels to said beam.

Said support beam is adapted to rotate about said hinge operated by a linear actuator, of electromechanical or hydraulic type: said actuator cooperates with said beam by means of a crank acting as lever arm.

In particular, said beam is integral with said crank, being firmly fastened thereto, for example by means of screws and bolts.

Said actuator has a first end hinged to one of said support poles, advantageously arranged in the center of said beam, and a second end hinged to said crank.

Opening or closing of said actuator causes lifting or lowering of said crank and consequent rotation, to the east or to the west, of said beam and of the photovoltaic panels fastened thereto.

To allow maximum rotation required for the row of panels, said crank must have a limited length, generally no greater than a quarter of the total width of the wing formed by the assembly of the panels coupled to one another, i.e., a quarter of the width of the array they produce.

These systems have some limits and disadvantages.

The main disadvantage consists in the use of a large number of actuators, one for each row of photovoltaic panels: a larger number of components for construction contribute to an increase in the total cost of the system, both from a mechanical and electrical viewpoint.

The structures of the photovoltaic systems are subject to stresses caused both by their own weight and by the weight of the panels, as well as by weather conditions and must, in particular, withstand the torques generated by the action of the wind and that act on the support beam of the same panels. For correct sizing of the system, each actuator must withstand a theoretical peak of the torque caused by the wind and acting on the respective row. As stated above, for reasons of geometry and bulk of the individual panels, the lever arm of each linear actuator must have a size such that it does not exceed the value of ¼ of the width of the wing of the photovoltaic panels: however, a small lever arm requires great effort by the actuator to have sufficient resistance to the torque to which the support beam of the panels is subjected. Unfortunately, this results in the use of actuators of greater force, which are therefore more costly.

### Presentation of the Invention

The aim of the invention is to overcome these limits by producing a structure for single-axis for tracking photovoltaic panels that:
allows systems with single-axis for tracking photovoltaic panels to be produced easily and economically, with a limited number of electromechanical components;
is stable in relation to external stresses and therefore very sturdy as a function of the resistance to the different environmental and weather conditions to which the panels can be subjected.

These objects are achieved with a load-bearing structure for single-axis for tracking photovoltaic panels comprising:
a first support beam for a plurality of photovoltaic panels, having a longitudinal axis adapted to be arranged in north-south direction;
a plurality of crosspieces for fixing said photovoltaic panels to said first beam;
a plurality of support poles for said first beam, arranged equidistant from one another, adapted to be secured to the ground and provided, at their free end, with a hinge connection adapted to allow the rotation of said first beam about its longitudinal axis;
a linear actuator having a first and a second end, where said first end is hinged to one of said support poles;
a first crank associated with said first beam and adapted to impart a rotation movement thereto,

characterized in that it comprises:
a second support beam for a plurality of photovoltaic panels, having a longitudinal axis adapted to be arranged in north-south direction, parallel to said first beam;
a plurality of crosspieces for fixing said plurality of photovoltaic panels to said second beam;
a plurality of support poles for said second beam, arranged equidistant to one another, adapted to be secured to the ground and provided, at their free end, with a hinge connection adapted to allow rotation of said second beam about its longitudinal axis;
a second crank associated with said second beam and adapted to impart a rotation movement thereto;
a connecting rod between said first and said second crank,

where said second end of said linear actuator is hinged to said connecting rod, to allow the simultaneous and coordinated movement of said first and said second crank and the consequent simultaneous and coordinated rotation of the respective first and second beam of said structure.

Advantageously, said linear actuator, said first crank, said second crank and said connecting rod are positioned in the central portion of said first and said second support beam.

In particular, the second end of said linear actuator acts on a substantially central portion of said connecting rod.

Moreover, said first and said second crank are firmly fastened by means of screws and bolts respectively to said first and said second support beam.

According to further aspects of the invention, said first and said second support beam comprise a quadrangular cross section, and said fixing crosspieces comprise an Ω cross section.

### Advantages of the Invention

The main advantage of the invention derives from its double row arrangement, which can be defined as “tandem”, where said first and said second support beam of the panels are parallel and moved by a single actuator by means of a connecting rod.

The actuator that acts on the first and on the second crank through a connecting rod makes it possible to obtain a greater length of the same cranks compared to those of single row systems, allowing the production of a more favorable lever arm, which makes it possible to reduce the force of the movement actuator.

With this two-row system, the number of actuators used and of mechanical components for connection and motion transmission are also drastically reduced, or halved, as are the electrical components for supplying and controlling said actuators, resulting in a saving of costs.

Advantageously, due to the fact that the lever arm of the actuator can be even double the length compared to the single row system, actuators of lower strength can also be used, with a further saving of both purchase and operating costs.

The maximum torque that acts on a single actuator is lower than the sum of the force peak of each single row, taking account of the factor reducing the probability of the two torques having the same maximum intensity in the same moment and in the same direction.

### BRIEF DESCRIPTION OF THE DRAWINGS

The advantages of the invention will be more evident below, in the description of a preferred method of embodiment, provided by way of non-limiting example, and with the aid of the drawings, wherein:

FIGS. 1 and 2 represent, in a top plan view and in a side view, a photovoltaic system with load-bearing structure for single-axis for tracking photovoltaic panels according to the invention;

FIGS. 3, 4 and 5 represent, in cross section, the load-bearing structure of FIG. 1 in three different positions based on the position of the sun over one day;

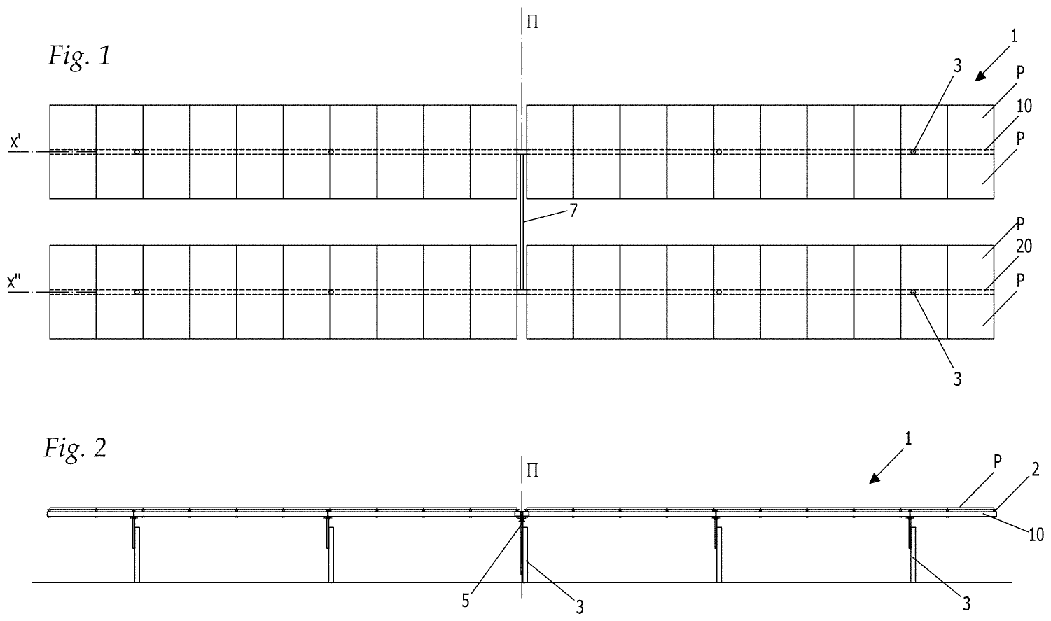

### MODE OF IMPLEMENTATION OF THE INVENTION

With reference to the figures, there is shown a photovoltaic system with load-bearing structure 1 for single-axis for tracking panels of the type in a double parallel row.

Said load-bearing structure 1 essentially comprises:
a first support beam 10 for a plurality of photovoltaic panels P, having a longitudinal axis x′ adapted to be arranged in north-south direction;
a second support beam 20 for a plurality of photovoltaic panels P, having a longitudinal axis x″ adapted to be arranged in north-south direction, parallel to said first beam 10;
a linear actuator 4 adapted to impart a rotation movement to said first 10 and said second 20 beam, where said movement is coordinated and transmitted simultaneously to both the beams 10, 20 by means of a connecting rod 7.

Said load-bearing structure 1 also comprises:
a plurality of crosspieces 2 for fixing said photovoltaic panels P to said first 10 and said second 20 beam;
a plurality of support poles 3 for said first 10 and said second 20 beam, arranged equidistant from one another, adapted to be secured to the ground.

Said fixing crosspieces 2 advantageously comprise an Ω cross section, on the wings of which the photovoltaic panels P are fastened by means of screws.

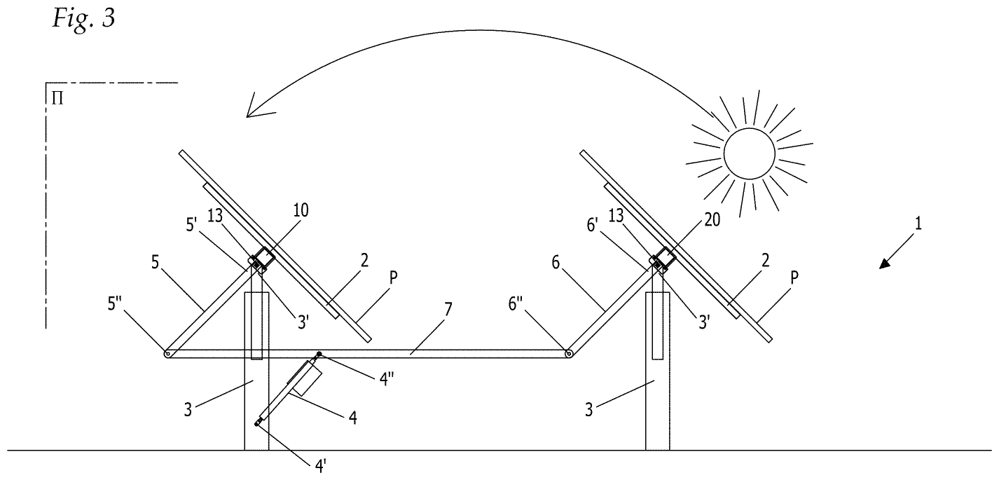

With particular reference to the sections of FIGS. 3-5, said first 10 and said second 20 support beam comprise a quadrangular cross section, and each support pole 3 is provided, at its free end 3′, with a hinge connection 13, adapted to allow the rotation about its longitudinal axis x′, x″ of the corresponding first 10 or second 20 beam it supports.

The sections illustrated belong to a transverse plane that intercepts the load-bearing structure 1 at its movement means, in particular of said linear actuator 4.

Said movement means act on the central portions of said first 10 and said second 20 support beam: in particular, said load-bearing structure 1 is substantially symmetrical with respect to a vertical plane π containing the axis of said linear actuator 4 and orthogonal to said beams, to ensure correct and homogeneous distribution of forces and allow the use of actuators of lower force.

As is apparent from the sections in question, said load-bearing structure 1 comprises a first crank 5 associated with said first beam 10 and a second crank 6 associated with said second beam 20.

Said first crank 5 comprises a first 5′ and a second 5″ end, where said first end 5′ is firmly associated with said first beam 10.

Said second crank 6 comprises a first 6′ and a second 6″ end, where said first end 6′ is stably associated with said second beam 20.

In particular, the first ends 5′, 6′ of said first 5 and said second 6 crank are firmly fastened with bolts respectively to said first 10 and said second 20 support beam to produce a fixed constraint.

The second ends 5″, 6″ of said first 5 and said second 6 crank are instead hinged to the ends of said connecting rod 7.

Said connecting rod 7 is arranged in horizontal position parallel to the ground.

Said linear actuator 4 has a first 4′ and a second 4″ end, where said first end 4′ is hinged to one of said support poles 3 of said first beam 10, while said second end 4″ is hinged to said connecting rod 7.

The second end 4″ of said linear actuator 4 acts on a substantially central portion of said connecting rod 7.

With particular reference to FIGS. 3-5, the movement of the load-bearing structure 1 as a function of the work of said linear actuator 4 can be noted.

Said linear actuator 4 is hinged to said connecting rod 7 to allow the simultaneous and coordinated movement of said first 5 and said second 6 crank and the consequent simultaneous and coordinated rotation of the respective first 10 and second 20 beam.

FIG. 3 illustrates the arrangement of the load-bearing structure 1 typical, for example, of the morning, where the panels P are facing east where the sun rises.

The linear actuator 4 is fully compressed, the connecting rod 7 translates horizontally toward the west the cranks 5, 6, the beams 10, 20 and the panels P integral therewith, tilted toward the east.

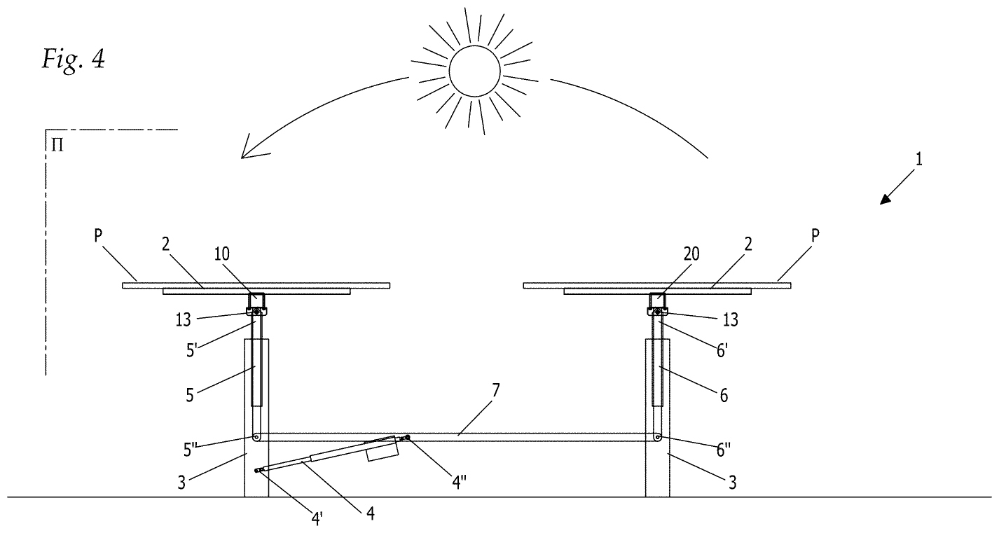

FIG. 4 illustrates the arrangement of the load-bearing structure 1 typical of the central hours of the day, where the linear actuator 4 is in the intermediate operating position, the cranks 5, 6 are perpendicular to the ground and the connecting rod 7 occupies the space between the two parallel rows of support poles 3.

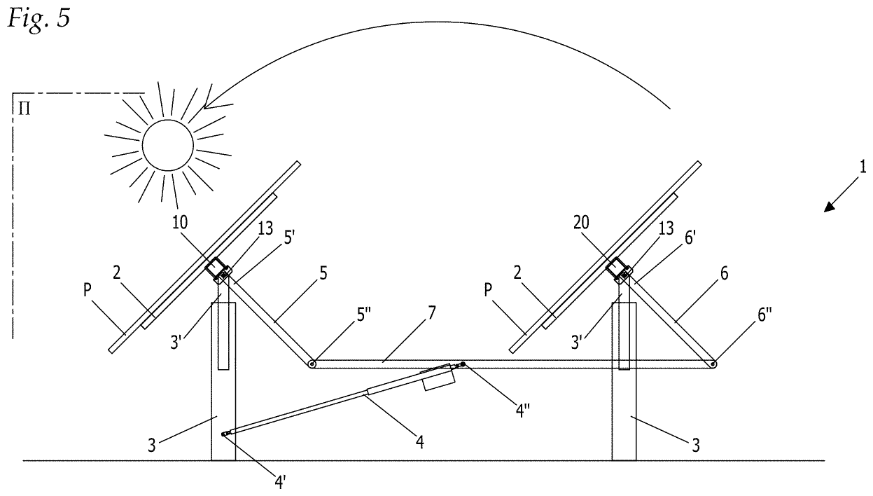

FIG. 5 illustrates the arrangement of the load-bearing structure 1 typical of the evening, where the panels P are facing west, where the sun sets.

The linear actuator 4 is fully extended, the connecting rod 7 translates horizontally toward the east the cranks 5, 6, the beams 10, 20 and the panels P integral therewith, tilted toward the west.

The invention has been described and illustrated with reference to panels without zenith orientation, but it is evident that the structure forming the subject matter of the present model is suitable also to support this type of orientation of the panels.

1. Load-bearing structure (1) for single axis for tracking photovoltaic panels (P) comprising:
a first support beam (10) for a plurality of photovoltaic panels (P), having a longitudinal axis (x′) adapted to be arranged in north-south direction;
a plurality of crosspieces (2) for fixing said photovoltaic panels (P) to said first beam (10);
a plurality of support poles (3) for said first beam (10), arranged equidistant to one another, adapted to be secured to the ground and provided, at their free end (3′), with a hinge connection (4) adapted to allow the rotation of said first beam (10) about its longitudinal axis (x′);
a linear actuator (4) having a first (4′) and a second (4″) end, where said first end (4′) is hinged to one of said support poles (3);
a first crank (5) associated with said first beam (10) and adapted to impart a rotation movement thereto,
characterized in that it comprises:
a second support beam (20) for a plurality of photovoltaic panels (P), having a longitudinal axis (x″) adapted to be arranged in north-south direction, parallel to said first beam (10);
a plurality of crosspieces (2) for fixing said plurality of photovoltaic panels (P) to said second beam (20);
a plurality of support poles (3) for said second beam (20), arranged equidistant from one another, adapted to be secured to the ground and provided, at their free end (3′), with a hinge connection (4) adapted to allow the rotation of said second beam (20) about its longitudinal axis (x″);
a second crank (6) associated with said second beam (20) and adapted to impart a rotation movement thereto;
a connecting rod (7) between said first (5) and said second (6) crank, where said second end (4″) of said linear actuator (4) is hinged to said connecting rod (7), to allow the simultaneous and coordinated movement of said first (5) and said second (6) crank and the consequent simultaneous and coordinated rotation of the respective first (10) and second (20) beam of said structure (1).

2. Load-bearing structure (1) according to claim 1, characterized in that said linear actuator (4), said first crank (5), said second crank (6) and said connecting rod (7) are positioned in the central portion of said first (10) and said second (20) support beam.

3. Load-bearing structure (1) according to claim 1, characterized in that the second end (4″) of said linear actuator (4) acts on a substantially central portion of said connecting rod (7).

4. Load-bearing structure (1) according to claim 1, characterized in that said first (5) and said second (6) crank are firmly fastened by means of screws and bolts respectively to said first (10) and said second (20) support beam.

5. Load-bearing structure (1) according to claim 1, characterized in that said first (10) and said second (20) support beam comprise a quadrangular cross section. Load-bearing structure (1) according to claim 1, characterized in that said fixing crosspieces (2) comprise an Ω cross section.
